(19) United States
(12) Patent Application Publication
(10) Pub. No.: US 2008/0028173 A1
(43) Pub. Date: Jan. 31, 2008

(54) SOFT MEDIA CHANGER

(75) Inventors: Yan Zhang, Sammamish, WA (US); Amit Amit, Redmond, WA (US); Mark F. Flores, Redondo Beach, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/611,082

(22) Filed: Dec. 14, 2006

Related U.S. Application Data
(60) Provisional application No. 60/820,453, filed on Jul. 26, 2006.

(51) Int. Cl. G06F 12/16; G06F 12/00

(52) U.S. Cl. 711/162; 711/115

(57) ABSTRACT

A first data is written to a removable storage medium at a target device. A request is received to eject the removable storage medium from the target device, wherein the removable storage medium is not ejected from the target device. The first data on the removable storage medium is copied to a storage location. The removable storage medium is presented as a new removable storage medium having been inserted into the target device.

### CROSS-REFERENCE TO RELATED APPLICATION

This application claims the benefit of U.S. Provisional Patent Application Ser. No. 60/820,453, filed Jul. 26, 2006, titled “Soft Media Changer”, which is incorporated herein by reference in its entirety.

### BACKGROUND

Users often desire to backup files on removable storage media, such as optical disks, using a backup application. A backup application often must perform media spanning. In media spanning, due to the size of the information to be preserved, the information is spread across multiple pieces of media. Current methods of testing a backup application's ability for media spanning are cumbersome and may involve excessive manual manipulation by a human tester.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention include a soft media changer. Data written to a removable storage medium is copied to another storage location, such as a hard disk drive (HDD). The same removable storage medium is then presented as a new removable storage medium to the backup application. The backup application may then write more data to the same removable storage medium. Similar operations may occur to restore the backed up data. In one embodiment, the soft media changer may be used to simulate media spanning for testing of a backup application.

Many of the attendant features will be more readily appreciated as the same becomes better understood by reference to the following detailed description considered in connection with the accompanying drawings.

### BRIEF DESCRIPTION OF THE DRAWINGS

Like reference numerals are used to designate like parts in the accompanying drawings.

FIG. 1 is a block diagram of an example computing device to implement embodiments of the invention.

FIG. 2 is a block diagram of an example computing environment to implement embodiments of the invention.

FIG. 3 is a flowchart showing the logic and operations of backing up data using a soft media changer in accordance with an embodiment of the invention.

FIG. 4 is a flowchart showing the logic and operations of restoring data using a soft media changer in accordance with an embodiment of the invention.

FIG. 5 is a flowchart showing the logic and operations of testing a backup application using a soft media changer in accordance with an embodiment of the invention.

FIG. 6 shows a soft media changer user interface in accordance with an embodiment of the invention.

FIG. 7 shows a backup application user interface in accordance with an embodiment of the invention.

FIG. 8 shows a soft media changer user interface in accordance with an embodiment of the invention.

FIG. 9 shows a soft media changer user interface in accordance with an embodiment of the invention.

FIG. 10 shows a backup application user interface in accordance with an embodiment of the invention.

FIG. 11 shows a soft media changer user interface in accordance with an embodiment of the invention.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

A backup application may allow users to backup their data (e.g., documents, music, video, pictures, emails, profile, etc.) to a target device and enable users to restore the data later. In one embodiment, a target device may use removable storage media. Embodiments of removable storage media include optical disks, magnetic disks, such as zip disks and jaz cartridges, and the like. In one embodiment, a backup application includes Windows Backup that is part of the Microsoft Windows Vista™ operating system.

Removable storage media may be used for backing up and restoring data. Examples of removable storage media include optical disks, such as CDs or DVDs. A user scenario may involve media spanning that may result in media changing. For example, a user that wants to backup a 5 GB file will need at least 7 CD-R disks (700 MB each). Thus, the user will need to change the CD-R media 7 times or more to complete the backup.

Embodiments herein provide for testing of a backup program that may entail changing of the media. Embodiments herein use a normal device (e.g., CD/DVD burner or a zip drive) to simulate the media changing. In embodiments herein, the simulated changing of removable storage media in a target device is programmatic and automated.

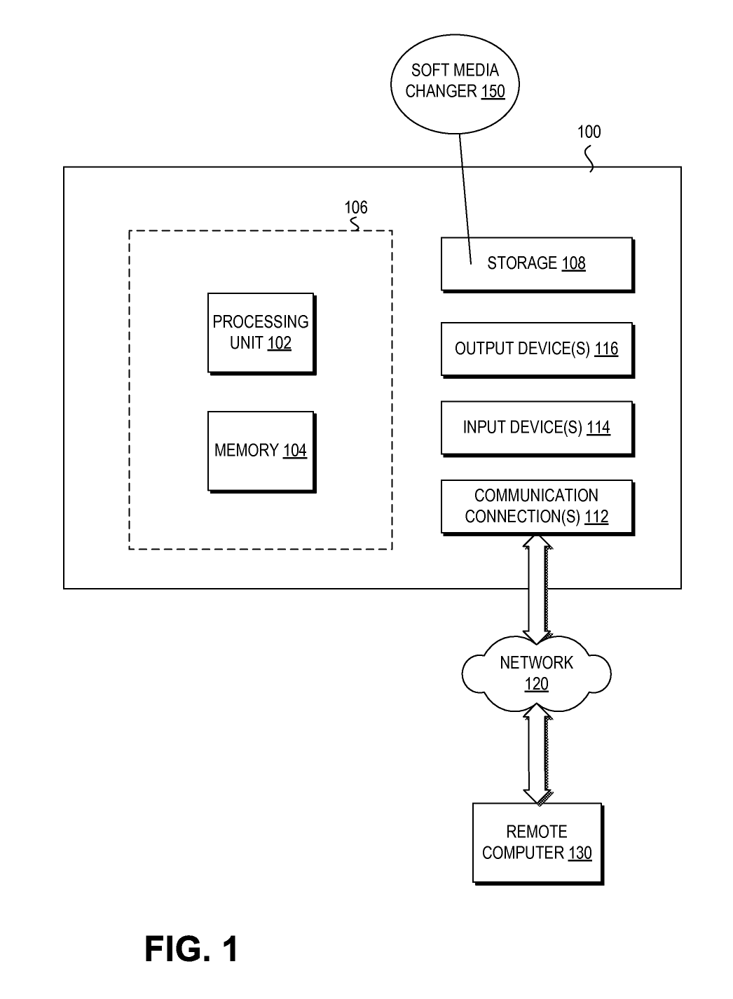

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing systems, environments, and/or configurations that may be suitable for use with embodiments described herein including, but not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, embodiments of the invention will be described in the general context of “computer readable instructions” being executed by one or more computers or other computing devices. Computer readable instructions may be distributed via computer readable media (discussed below). Computer readable instructions may be implemented as program modules, such as functions, objects, application programming interfaces, data structures, and the like, that perform particular tasks or implement particular abstract data types. Typically, the functionality of the computer readable instructions may be combined or distributed as desired in various environments.

FIG. 1 shows an exemplary system for implementing one or more embodiments of the invention in a computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by storage 108. In one embodiment, computer readable instructions to implement embodiments of the invention may be stored in storage 108, such as shown by a soft media changer 150. Storage 108 may also store other computer readable instructions to implement an operating system, an application program, and the like.

The term “computer readable media” as used herein includes both computer storage media and communication media. Computer storage media includes volatile and nonvolatile, removable and non-removable media implemented in any method or technology for storage of information such as computer readable instructions, data structures, program modules, or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also include communication connection(s) 112 that allow device 100 to communicate with other devices, such as remote computer 130, through network 120. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may also have input device(s) 114 such as keyboard, mouse, pen, voice input device, touch input device, laser range finder, infra-red cameras, video input devices, and/or any other input device. Output device(s) 116 such as one or more displays, speakers, printers, and/or any other output device may also be included. Input device(s) 114 or output device(s) 116 may be connected to device 100 using wired connections, wireless connections, any combination thereof.

Those skilled in the art will realize that storage devices utilized to store computer readable instructions may be distributed across a network. For example, a remote computer 130 accessible via network 120 may store computer readable instructions to implement one or more embodiments of the invention. Computing device 100 may access remote computer 130 and download a part or all of the computer readable instructions for execution. Alternatively, computing device 100 may download pieces of the computer readable instructions, as needed, or some instructions may be executed at computing device 100 and some at remote computer 130. Those skilled in the art will also realize that all or a portion of the computer readable instructions may be carried out by a dedicated circuit, such as a Digital Signal Processor (DSP), programmable logic array, and the like.

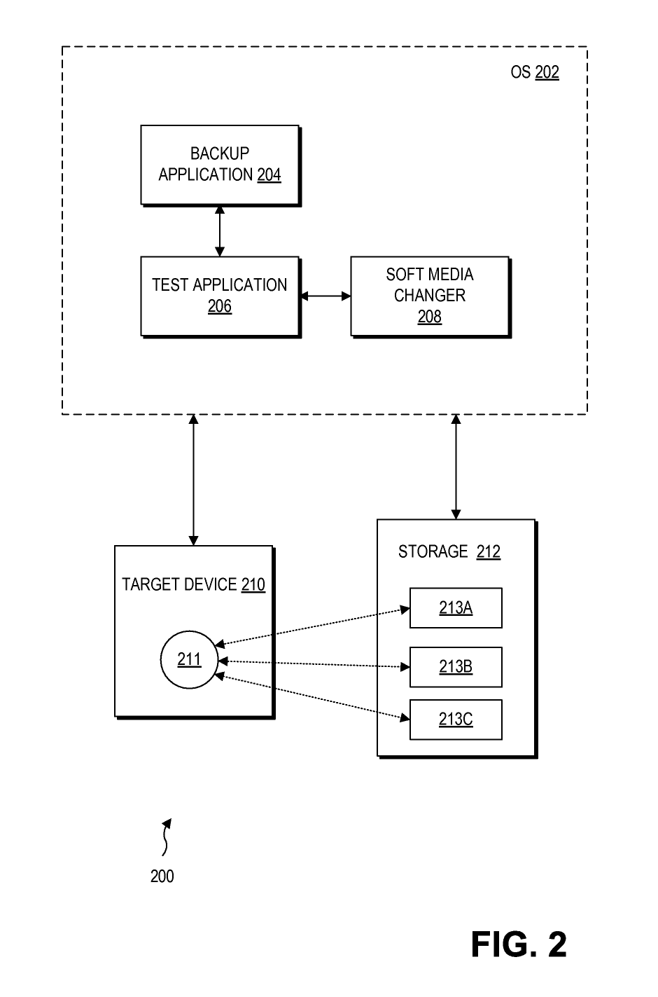

Turning to FIG. 2, an embodiment of a computing device 200 including a soft media changer 208 is shown. Computing device 200 includes an operating system 202. Operating system 202 supports a backup application 204. Backup application 204 may be used to backup and restore data using a target device 210.

In one embodiment, backup application 204 is monitored by a test application 206. Test application 206 may be used for setting up test scenarios for backup application 204 and recording test results. In one embodiment, scripting may be used to automate test scenarios and inject faults into the system for testing backup application 204.

Test application 206 communicates with soft media changer 208 for simulating media changing. In one embodiment, data is written to a physical medium. When an eject operation is requested, the data written on the medium is copied to another storage location, such as a hard disk drive (HDD). The same medium is then presented as a fresh piece of media. These operations are repeated until the backup operation is completed. Restoring the data is performed in a similar manner (discussed below).

In the embodiment of FIG. 2, target device 210 is used by backup application 204 for backing up data. In one embodiment, target device 210 includes a removable storage medium 211. In one embodiment, medium 211 is rewriteable. For example, optical disks may be CD-RW or DVD-RW. For other types of medium 211, such as a magnetic disk, medium 211 is not write-protected. Medium 211 may be rewriteable or not write-protected so that the same removable storage medium 211 may be written to (and erased in some cases) multiple times to simulate spanning across several media.

In another embodiment, target device 210 includes a virtual device. The virtual device is a software simulation of a storage device and its removable storage medium. Such simulated storage devices include optical disk drives, magnetic disk drives, and the like. A virtual device provides functionality as the actual storage device such as read/write, media insert/eject, and the like. A virtual device appears as an actual device to OS 202 and applications supported by OS 202.

In one embodiment, a virtual device may be reconfigured automatically to simulate different storage devices (for example, from a CD-ROM to a DVD). In one embodiment, the virtual device may be reconfigured through scripting to provide automated testing of backup application 204 with various types of storage devices, removable storage media, file formats, and the like.

Computing device 200 may include storage 212, such as a hard disk drive. Storage 212 is used for storing data copied from removable storage medium 211. In some embodiments, data copied from medium 211 may be stored on multiple storage devices 212. In an alternative embodiment, storage 212 may include a storage device accessible by device 200 over a network.

In one embodiment, soft media changer 208 includes one or more Application Programming Interfaces (APIs) that may be called by test application 206 (or other callers). Such APIs include ejecting media, inserting media, cleaning media, damaging media, simulating user faults, and the like. Other APIs may include creating storage locations for data saved to media and finding data that has been stored (discussed below).

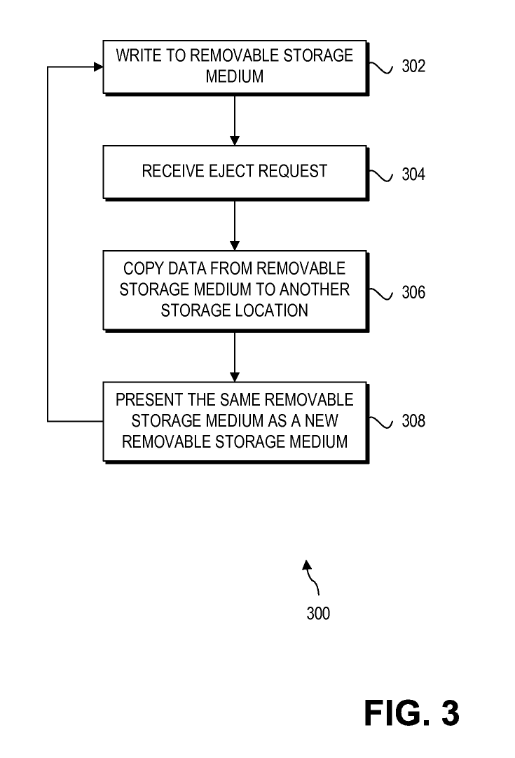

Turning to FIG. 3, a flowchart 300 shows the logic and operations of backing up data using a soft media changer in accordance with an embodiment of the invention. Starting in block 302, data is written to the removable storage medium. Referring to FIG. 2, data is written to medium 211 by target device 210.

Continuing to block 304, an eject request is received. In one embodiment, the eject request is made by backup application 204. In this embodiment, backup application 204 is trying to backup data that is too large to fit on a single medium 211. Backup application 204 is requesting that the current medium be removed and a new removable storage medium be inserted so that the backup may continue. In one embodiment, test application 206 intercepts the eject request. Test application 206 may then call the appropriate API from soft media changer 208. The eject request is disregarded and not performed at the target device. In one embodiment, backup application is unaware of the simulated media swapping being performed by soft media changer 208.

Proceeding to block 306, data is copied from the removable storage medium to another storage location. In FIG. 2, data may be copied to storage location 213A of storage 212. A storage location, such as 213A, may include one or more files, a folder including one or more files, or any other method for storing associated data.

In one embodiment, the location for storing the data is determined by soft media changer 208. Soft media changer 208 may search device 200 and find a HDD partition with the largest free space and use this free space. In another embodiment, a user may explicitly specify the data storage location.

Continuing to block 308, the same removable storage medium in the target device is presented to the backup application as a new removable storage medium. Thus, the requester, such as backup application 204, believes that a new piece of media has been inserted into the target device. In one embodiment, the medium may be cleaned (or erased) of the previously saved data by soft media changer 208. The logic may then return to block 302 to write more data to the removable storage medium. The logic of flowchart 300 may repeat as necessary to complete the backup operation.

In the embodiment of FIG. 2, medium 211 remains in target device 210 but is presented to backup application 204 as a new removable storage medium. In FIG. 2, data has been written three times to medium 211 and copied to locations 213A, 213B, and 213C. For example, backup application 204 believes a backup operation has been spanned across three different optical disks A, B, and C, but in reality, the data has been stored in three locations 213A, 213B, and 213C. In actuality, the same optical disk remained in target device 210 during the backup operation and was never removed from target device 210.

In one embodiment, data corresponding to a piece of media is stored at storage 212 with unique indicia for identifying the data. In this way, any previously written data to the removable storage medium may be rewritten back to the removable storage medium from the storage location. For example, assume storage location 213B has been uniquely identified with an optical disk B. In a restore operation when backup application 204 requests optical disk B, then soft media changer 208 may write the requested data from storage location 213B to medium 211. Medium 211 may then be presented to backup application 204 as the requested optical disk B.

In an alternative embodiment, the data corresponding to a piece of media may not use unique indicia if the data corresponding to each piece of media is stored in a unique storage location. For example, data corresponding to optical disks A, B, and C may be stored in three separate HDDs, three separate HDD partitions on the same HDD, or any combination thereof.

In one embodiment, a medium name is used to create a folder and data copied from the removable storage medium is stored in the folder. Thus, each piece of media has its own corresponding folder. If more information for the medium and/or the data on the medium is needed, then a metadata file may be generated and stored in the folder as well. In one embodiment, to store data locally, a root folder is created and the root folder's full path is put into a registry key so any later operation can find the folder and use the information in the folder.

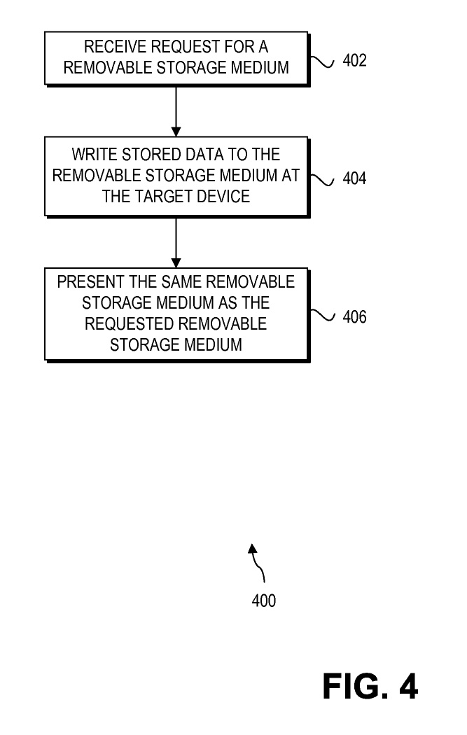

Turning to FIG. 4, a flowchart 400 shows the logic and operations of restoring data using a soft media changer in accordance with an embodiment of the invention. Starting in block 402, a request for a removable storage medium is received. In the embodiment of FIG. 2, test application 206 intercepts a request from backup application 204.

Continuing to block 404, the stored data is written to the removable storage medium already at the target device. Proceeding to block 406, the same removable storage medium is presented as the requested removable storage medium. For example, in FIG. 2, if optical disk B is requested, data from location 213B is written to medium 211. Medium 211 is then presented as the requested removable storage medium. The logic of flowchart 400 may be repeated as needed to fulfill requests for media, however, the physical medium 211 is not actually ever inserted/removed from target device 210.

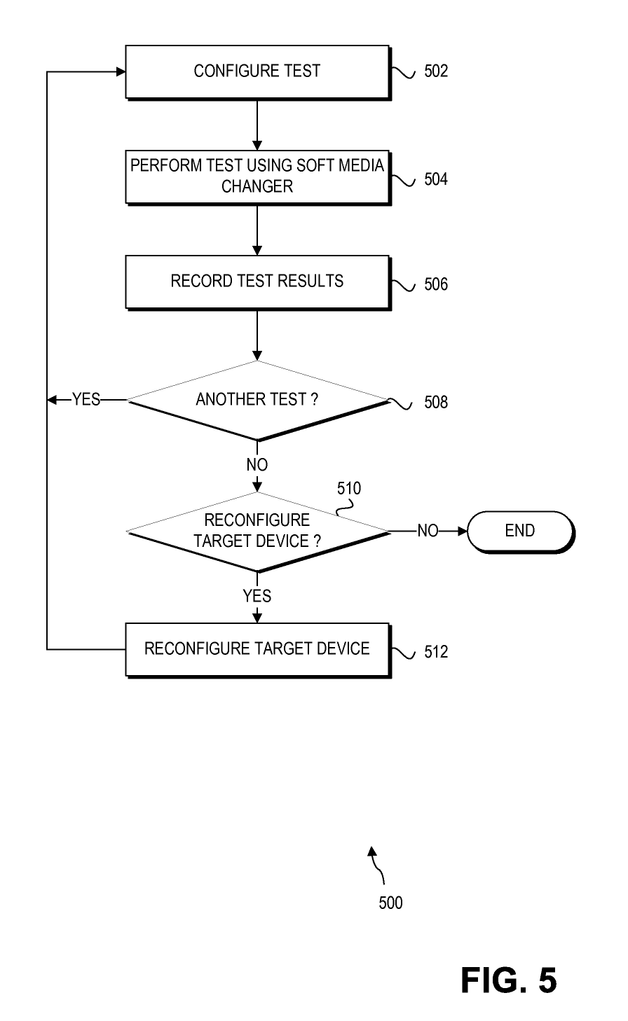

Turning to FIG. 5, a flowchart 500 shows the logic and operations of testing a backup application using a soft media changer in accordance with an embodiment of the invention. Starting in block 502, a test of the backup application is configured. Examples tests are discussed below. In one embodiment, tests may be injected via a script run by test application 206. This allows for automated testing of backup application 204 using soft media changer 208. Because soft media changer 208 simulates media changing, a physical media changer or a human performing the media changing is not needed for the testing.

Proceeding to block 504, the test is performed using the soft media changer for media spanning. In one embodiment, backup application 204 is tested for its ability to detect and handle various errors. In block 506, the test results are recorded. In one embodiment, the results are recorded by test application 206.

Continuing to decision block 508, the logic determines if another test is to be performed. If the answer is yes, the logic returns to block 502. If the answer is no, then the logic continues to decision block 510.

In decision block 510, the logic determines if the target device is to be reconfigured. If the answer is yes, then the logic continues to block 512 to reconfigure the target device and then returns to block 502 to test the reconfigured device. In some embodiments, target device may be reconfigured to other storage capacities, different types of removable storage media, different media block sizes, and different file formats (discussed below). If the answer to decision block 510 is no, then flowchart 500 ends.

Embodiments of the invention make media spanning test cases easy to simulate and reproduce. Embodiments of such test cases include media failure, file corruption, disk spanning errors, and user fault scenarios. Recognition and handling by backup application 204 of other events may include mount/dismount the target device, plug/unplug the target device from the system, power on/off at the target device, eject/insert media, and the like.

For example, soft media changer 208 may simulate a media failure such as a scratched optical disk. In this example, the data stored on a HDD may be easily corrupted for testing and written to medium 211. Test application 206 may then determine if backup application 204 detects this data corruption in a restore operation. This error may be simulated without damaging the original medium data stored on the HDD. Error cases may be easily reproduced since the original medium data is kept untouched.

In another example, file corruption, such as through an Input/Output (I/O) error, may be tested. In this case, removable storage medium 211 is undamaged, but the data itself has been read or written incorrectly. Again, since the original medium data is preserved on storage 212, the error may be repeated as desired when reading or writing to removable storage medium 211.

In one embodiment, soft media changer 208 may simulate error cases that may occur during the middle of a media spanning operation. In one embodiment, these error cases may be simulated using Win32 APIs or Virtual Disk Services (VDS) APIs. These error cases may include medium full, unformatted medium, removable storage media device disconnected, and/or device swap.

A device swap error involves a change to a different compatible device or a change to a non-compatible device. For example, in the compatible case, a CD writer has been swapped with a DVD writer. In the non-compatible case, a zip drive has been swapped with a DVD writer.

Embodiments of the invention may test the ability of the backup application to handle a scenario where the user has swapped their target device during a backup operation (e.g., target device plug/unplug). In one embodiment, backup application 204 may operate in the background on a regular schedule (for example, backup the local HDD every Sunday at 2:00 AM). In this scenario, the user may not realize that the backup application was performing a backup operation at the time of the device swap.

Soft media changer 208 may also simulate user fault operations. For example, medium A is requested, but the user mistakenly inserts medium B. In this example, soft media changer 208 may write data from location 213B to removable storage medium 211 when data from location 213A is what is actually being requested by backup application 204. The test would determine if backup application 204 detects the error. In another example, soft media changer may simulate that the user inserted a dirty medium (i.e., a medium already having saved data) when the backup application 204 requested a clean medium (i.e., formatted medium without previously saved data).

Embodiments of soft media changer 208 provide for reconfiguring target device 210, such as in block 512 of flowchart 500. In one embodiment, reconfiguration of target device 210 may be initiated by test application 206 as part of automated testing. In one embodiment, a virtual device used as target device 210 may be reconfigured.

In one example, the size and/or type of removable storage medium 211 may be configured. For example, media changing of CDs and DVDs may occur on the same optical drive. In another example, the same media type, such as optical disks, having different storage capacities may be mixed together in a media spanning operation. In one example, an optical disk with a large storage capacity (e.g., 100 GB) may be tested even though such an optical disk is not yet available.

In another example, different file formats may also be simulated and tested. Such file formats include File Allocation Table (FAT), NT file system (NTFS), and the like. Also, different block sizes used on removable storage medium 211 may be simulated.

In one embodiment, soft media changer 208 may include a User Interface (UI) to enable a human user to interact with soft media changer 208. In one example, a tester may wish to test backup application 204 without using automated scripting through test application 206. In another example, a user may want to use backup application 204 to backup data without physically swapping multiple removable storage media. A soft media changer UI enables a user to “swap” media in a matter of seconds rather than manually inserting and ejecting physical media. Instead of using multiple removable storage media for media spanning, the user may backup data to multiple locations on one or more storage devices.

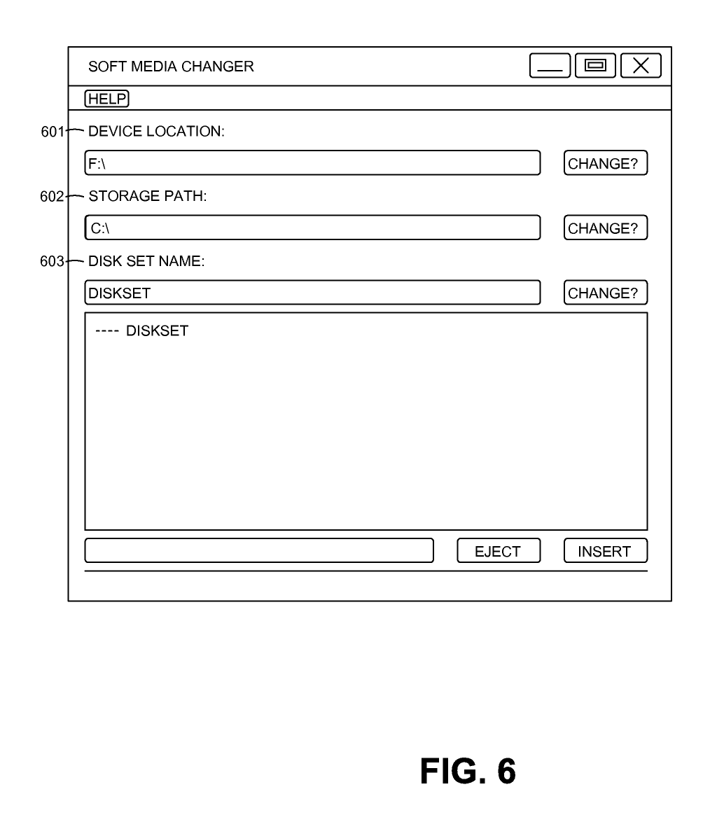

Turning to FIGS. 6-9, user interfaces associated with a backup operation are shown. In FIG. 6, an embodiment of a soft media changer user interface is shown. At 601, a user may set the location of target device 210. At 602, a user may set the storage path for the data copied from the removable storage medium, such as a path to storage 212. At 603, the user may assign a name to a set of disks the data is being spanned across by backup application 204. In FIG. 6, the disk set is named “DiskSet.”

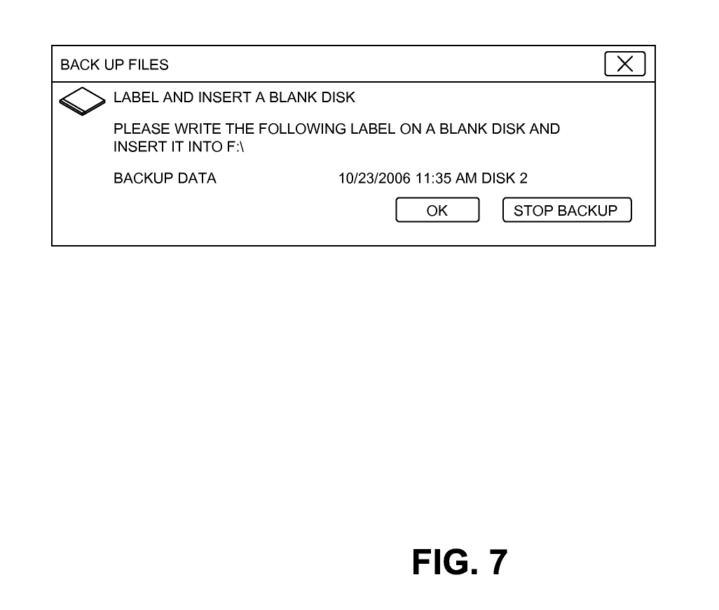

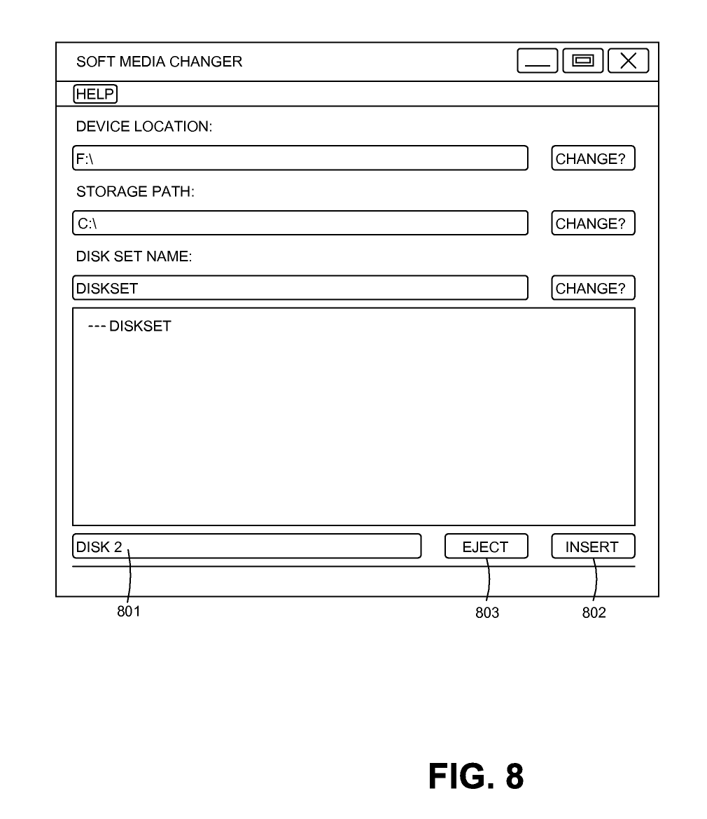

FIG. 7 shows an embodiment of a backup application user interface. In this instance, backup application 204 is requesting a blank disk be inserted in the target device to continue backing up the data. In FIG. 8, the user may use the soft media changer UI to name a new disk “Disk 2” (as shown at 801) and press button “Insert” (shown at 802) to insert the new disk into target device 210. However, in actuality, the data written to removable storage medium 211 in target device 210 is copied to storage 212 and removable storage medium 211 remains in target device 210. Removable storage medium 211 is presented to backup application 204 as a blank disk as requested in FIG. 7.

The soft media changer UI also includes an “Eject” button (shown at 803). The “Eject” button may be used to eject media from target device 210. However, in actuality, the medium is not ejected from target device 210, but remains in target device 210.

The “Insert” and “Eject” buttons may be used to satisfy requests such as from backup application 204. In this way, backup application 204 does not have to be modified in order to operate with soft media changer 208. In one embodiment, after a new disk is inserted using “Insert” button 802, backup application 204 may continue operations in response to user interaction with the backup application UI. In another embodiment, an application receives event completion notifications of an actual insert or eject and may automatically respond accordingly.

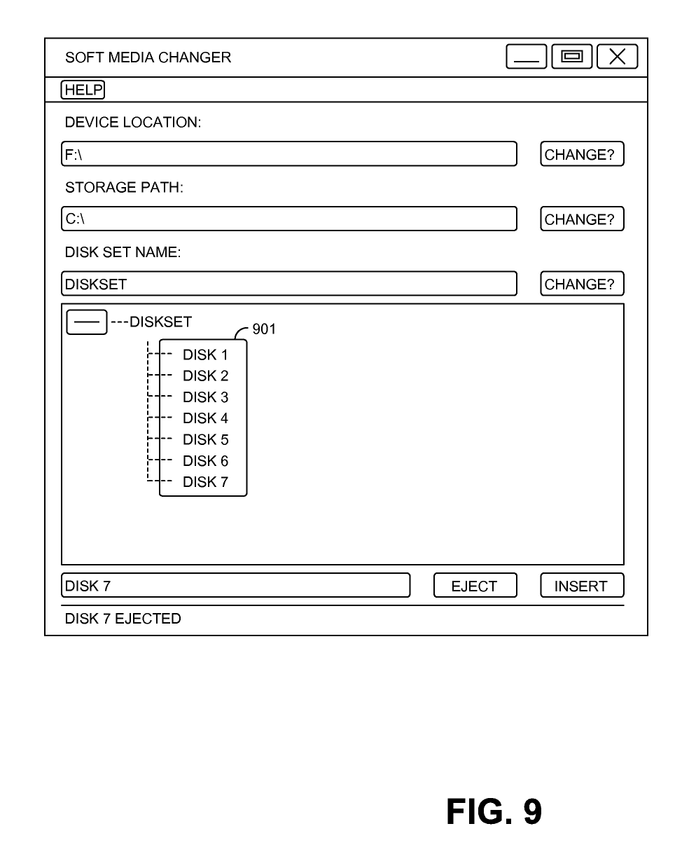

FIG. 9 shows the soft media changer UI after the backup operation has been completed. At 901, a tree view of the backup disk set is shown. Thus, backup application 204 believes data has been saved to 7 disks, but in reality, the data was saved to multiple storage locations, such as at 7 folders on storage 212.

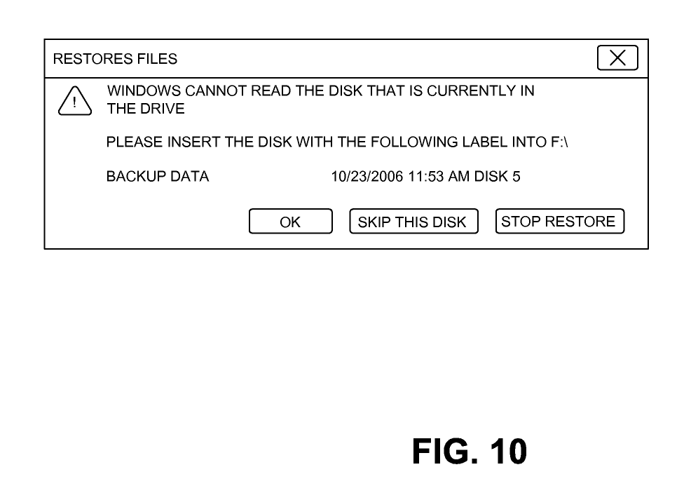

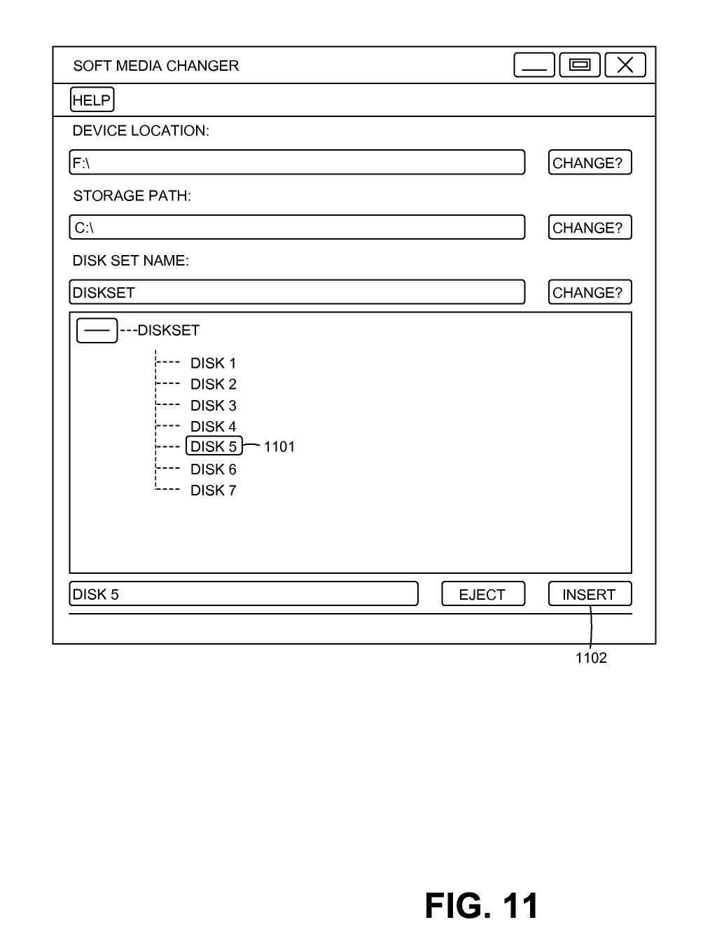

Turning to FIGS. 10 and 11, user interfaces associated with a restore operation are shown. In this scenario, backup application is attempting to restore data saved on multiple disks. In actuality, the “backup disks” are saved on storage 212. In FIG. 10, a backup application UI indicates that backup application 204 is requesting that backup “Disk 5” be inserted into target device 210. In FIG. 11, a soft media changer UI may be used to select “Disk 5” from the disk set (as shown at 1101) and insert “Disk 5” into target device 210 by pressing “Insert” (shown at 1102). In this case, data corresponding to “Disk 5” is copied from storage 212 and written to removable storage medium 211 in target device 210. Removable storage medium 211 is then presented to backup application 204 as the requested “Disk 5.”

Embodiments of the invention provide a soft media changer for performing media spanning operations without physically manipulating multiple removable storage media. Thus, a physical media changer or a person to physically eject and insert media is not necessary. In a test environment, the soft media changer provides for automation of media changing. Also, the soft media changer may be used for testing error handling by a backup application. In another embodiment, a soft media changer UI enables operation of the soft media changer by a human user.

Various operations of embodiments of the present invention are described herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
writing first data to a removable storage medium at a target device;
receiving a request to eject the removable storage medium from the target device, wherein the removable storage medium is not ejected from the target device;
copying the first data on the removable storage medium to a storage location; and
presenting the removable storage medium as a new removable storage medium having been inserted into the target device.

2. The method of claim 1, further comprising writing second data to the removable storage medium.

3. The method of claim 1, further comprising:
receiving a request for a second removable storage medium to be inserted into the target device;
writing second data stored at the storage location to the removable storage medium, wherein the second data includes data associated with the requested second removable storage medium; and
presenting the removable storage medium as the requested second removable storage medium.

4. The method of claim 1 wherein the target device and the removable storage medium are simulated by a virtual device.

5. The method of claim 4, further comprising reconfiguring the virtual device to appear as a different target device to an operating system.

6. The method of claim 1, further comprising providing indicia to the first data copied to the storage location to associate the first data with a first removable storage medium.

7. The method of claim 1 wherein the request to eject the removable storage medium is initiated by a test application.

8. The method of claim 1 wherein the request to eject the removable storage medium is initiated by a user interface.

9. One or more computer readable media including computer readable instructions that, when executed, perform the method of claim 1.

10. One or more computer readable media including computer readable modules, comprising:
a backup module, wherein the backup module to request media spanning of data across two or more removable storage media in a target device; and
a soft media changer module, wherein the soft media changer module to simulate media spanning of data across the two or more removable storage media in the target device in response to requests from the backup module, wherein a single removable storage medium to remain at the target device during the media spanning.

11. The one or more computer readable media of claim 10 wherein to simulate media spanning includes storing data at two or more storage locations corresponding to the two or more removable storage media.

12. The one or more computer readable media of claim 10 wherein to simulate media spanning includes recovering data from two or more storage locations corresponding to the two or more removable storage media.

13. The one or more computer readable media of claim 10 further comprising a test module to test the backup module using the soft media changer module.

14. The one or more computer readable media of claim 13 wherein a test of the backup module includes at least one of: a media failure at the single removable storage medium, corrupted data stored on the single removable storage medium, and a user fault in responding to a removable storage medium associated request at the target device.

15. The one or more computer readable media of claim 10 wherein the soft media changer module to include a user interface, wherein the soft media changer module to conduct the media spanning in response to user inputs at the user interface.

16. A method, in a computing device including a target device having a removable storage medium, for providing user interaction with a soft media changer user interface on a display, comprising:
displaying the soft media changer user interface on the display;
receiving an execution signal corresponding to an insert command on the soft media changer user interface; and
executing the insert command in response to the execution signal, wherein the insert command to present the removable storage medium as a new removable storage medium having been inserted into the target device, wherein data stored on the removable storage medium is copied to a storage location.

17. The method of claim 16 wherein the insert command to present the removable storage medium as a requested second removable storage medium, the requested second removable storage medium selected on the soft media changer user interface, wherein data associated with the requested second removable storage medium copied to the removable storage medium.

18. The method of claim 16, further comprising:
receiving an execution signal corresponding to an eject command on the soft media changer user interface; and
executing the eject command in response to the execution signal, wherein the eject command to indicate the removable storage medium has been ejected from the target device when in actuality the removable storage medium remains in the target device.

19. The method of claim 16, further comprising:
receiving an execution signal corresponding to a target device location command on the soft media changer user interface; and
executing the target device location command in response to the execution signal, wherein the target device location command to indicate the location of the target device.

20. The method of claim 16, further comprising:
receiving an execution signal corresponding to a storage path command on the soft media changer user interface; and
executing the storage path command in response to the execution signal, wherein the storage path command to assign the storage location of data copied from the removable storage medium.
